(19) United States
(12) Patent Application Publication
(10) Pub. No.: US 2020/0349933 A1
(43) Pub. Date: Nov. 5, 2020

(54) Speech Dialog System Aware of Ongoing Conversations

(71) Applicant: Nuance Communications, Inc., Burlington, MA (US)

(72) Inventors: Tobias Wolff, Neu-Ulm (DE); Nils Lenke, Rheinbach (DE)

(21) Appl. No.: 16/398,833

(22) Filed: Apr. 30, 2019

(51) Int. Cl. G10L 15/22; G10L 25/78; G10L 15/18

(52) U.S. Cl. CPC G10L 15/22; G10L 15/1815; G10L 15/1807; G10L 25/78

(57) ABSTRACT

Disclosed are systems and methods aware of ongoing conversations and configured to intelligently schedule a speech prompt to an intended addressee. A method for intelligently scheduling a speech prompt in a speech dialog system includes monitoring an acoustic environment to detect an intended addressee's availability for a speech prompt having a measure of urgency corresponding therewith. Based on the intended addressee's availability, the method predicts a time that is convenient to present the speech prompt to the intended addressee, and schedules the speech prompt based on the predicted time and the measure of urgency. A measure of rudeness can be estimated using a cost function that includes cost for presence of an utterance, cost for presence of a conversation, and cost for involvement of the intended addressee in the conversation. Scheduling the speech prompt can include trading off the measure of urgency and the measure of rudeness.

### BACKGROUND

Traditional speech dialog systems usually playback prompts as soon as the respective information is available to the system. This happens regardless of the current conversational situation the user may in at that time. For example, the driver of a vehicle can be in a conversation with a passenger, yet the navigation system may barge-in and interrupt the conversation. This may not only be perceived as “impolite” or annoying by the user, e.g., the driver, but the user might also miss the information being prompted.

### SUMMARY

Disclosed herein are systems and methods that are aware of an ongoing conversation and that are configured to make use of this awareness to intelligently schedule a speech prompt to an intended addressee.

An example embodiment of a method for intelligently scheduling a speech prompt in a speech dialog system includes monitoring an acoustic environment to detect an intended addressee's availability for a speech prompt having a measure of urgency corresponding therewith. Based on the intended addressee's availability, a time is predicted that is convenient to present the speech prompt to the intended addressee. The speech prompt is scheduled based on the predicted time and the measure of urgency.

Monitoring the acoustic environment can include detecting an acoustic signal associated with the acoustic environment to produce a detected acoustic signal, applying speech signal enhancement to the detected acoustic signal to produce an enhanced detected acoustic signal, and generating an enhanced speech signal and a speech activity signal as a function of the enhanced detected acoustic signal.

The method for intelligently scheduling the speech prompt can include detecting dialog from the speech activity signal. Alternatively, or in addition, the method can include capturing a video signal associated with the acoustic environment and applying visual speech activity detection to the video signal to generate a visual speech activity signal. The dialog can be detected from the speech activity signal, the visual speech activity signal, or both.

The method can include applying voice biometry analysis to the enhanced speech signal to detect involvement of the intended addressee in the dialog. The method can include applying one or more of automatic speech recognition, prosody analysis, and syntactic analysis to the enhanced speech signal to generate one or more speech analysis results. Pause prediction can be applied to the enhanced speech signal based on the one or more speech analysis results.

Predicting the time that is convenient to present the speech prompt can include estimating rudeness of interruption based on the pause prediction and dialog detection to generate a measure of rudeness. The measure of rudeness can be estimated using a cost function that includes cost for presence of an utterance, cost for presence of a conversation, and cost for involvement of the intended addressee in the conversation.

Scheduling the speech prompt can include trading off the measure of urgency and the measure of rudeness. The trading off can include computing an urgency-rudeness ratio as the ratio of the measure of urgency and the measure of rudeness. The prompt can be scheduled based on a comparison of the urgency-rudeness ratio to a threshold. The threshold may be pre-selected according to a particular application but the system may allow adjustment of the threshold, e.g., in response to user input or in response to timing considerations.

An example embodiment of a speech dialog system for intelligently scheduling a speech prompt includes a dialog manager, a scheduler configured to schedule the speech prompt, and a processor in communication with the dialog manager and scheduler. The dialog manager is configured to monitor an acoustic environment to detect an intended addressee's availability for a speech prompt having a measure of urgency corresponding therewith. The processor is configured to (i) predict a time that is convenient to present the speech prompt to the intended addressee based on the intended addressee's availability, and (ii) cause the scheduler to schedule the speech prompt based on the predicted time and the measure of urgency.

The system can include a microphone system configured to detect an acoustic signal associated with the acoustic environment to produce a detected acoustic signal. A speech processor, in communication with the dialog manager, can be configured to apply speech signal enhancement to the detected acoustic signal to produce an enhanced detected acoustic signal. The speech processor can be configured to generate an enhanced speech signal and a speech activity signal as a function of the enhanced detected acoustic signal. The dialog manager can be configured to detect dialog from the speech activity signal.

The system can include a camera that is configured to capture a video signal associated with the acoustic environment. A video processor, in communication with the dialog manager, can be configured to apply visual speech activity detection to the video signal to generate a visual speech activity signal. The dialog manager can be configured to detect the dialog from the speech activity signal and the visual speech activity signal.

The system can include a voice analyzer that is in communication with the dialog manager and that is configured to apply voice biometry analysis to the enhanced speech signal to detect involvement of the intended addressee in the dialog.

The system can include a speech recognition engine that is in communication with the processor and configured to apply one or more of automatic speech recognition, prosody analysis, and syntactic analysis to the enhanced speech signal to generate one or more speech analysis results.

The processor can be configured to apply pause prediction to the enhanced speech signal based on the one or more speech analysis results. For example, the processor can be configured to predict the time that is convenient to present the speech prompt by estimating rudeness of interruption based on the pause prediction and dialog detection to generate a measure of rudeness. The processor can be configured to cause the scheduler to schedule the speech prompt by trading off the measure of urgency and the measure of rudeness.

An example embodiment of a non-transitory computer-readable medium includes computer code instructions stored thereon for intelligently scheduling a speech prompt in a speech dialog system, the computer code instructions, when executed by a processor, cause the system to perform at least the following: monitor an acoustic environment to detect an intended addressee's availability for a speech prompt having a measure of urgency corresponding therewith; based on the intended addressee's availability, predict a time that is convenient to present the speech prompt to the intended addressee; and schedule the speech prompt based on the predicted time and the measure of urgency.

Embodiments have several advantages over prior approaches. Embodiments improve the situation of perceived impoliteness or rudeness that plagues traditional dialog systems by making the dialog system aware of ongoing conversations and by introducing “empathy” into the human machine conversation. Advantageously, a speech dialog system in accordance with an embodiment will be perceived as less annoying by the user. Further, prompts are more likely to be understood by the user. This can lead to a higher acceptance of the speech dialog system by the user. Also, this can increase the likelihood of successfully conveying the prompted information to the user.

Making human-machine communication as natural as possible has a high commercial potential because the feature of the dialog system's awareness of ongoing conversations is detectable to the end user and directly improves user experience.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 illustrates an example of a prior arrangement for a voice controlled user interface.

FIG. 2 illustrates a speech dialog system in a vehicle, according to an example embodiment.

FIG. 3 is a block diagram of a system and associated method for scheduling a speech prompt, according to an example embodiment.

FIG. 4 is a flow chart illustrating a method of scheduling a speech prompt, according to an example embodiment.

### DETAILED DESCRIPTION

A description of example embodiments follows.

Automatic speech recognition (ASR) systems typically are equipped with a signal preprocessor to cope with interference and noise, as described in WO2013/137900A1, entitled “User Dedicated Automatic Speech Recognition” and published Sep. 19, 2013. Often multiple microphones are used, e.g., microphones arranged in an array, particularly for distant talking interfaces where the speech enhancement algorithm is spatially steered towards the assumed direction of the speaker (beamforming). Consequently, interferences from other directions can be suppressed. This improves the ASR performance for the desired speaker, but decreases the ASR performance for others. Thus, the ASR performance depends on the spatial position of the speaker relative to the microphone array and on the steering direction of the beamforming algorithm.

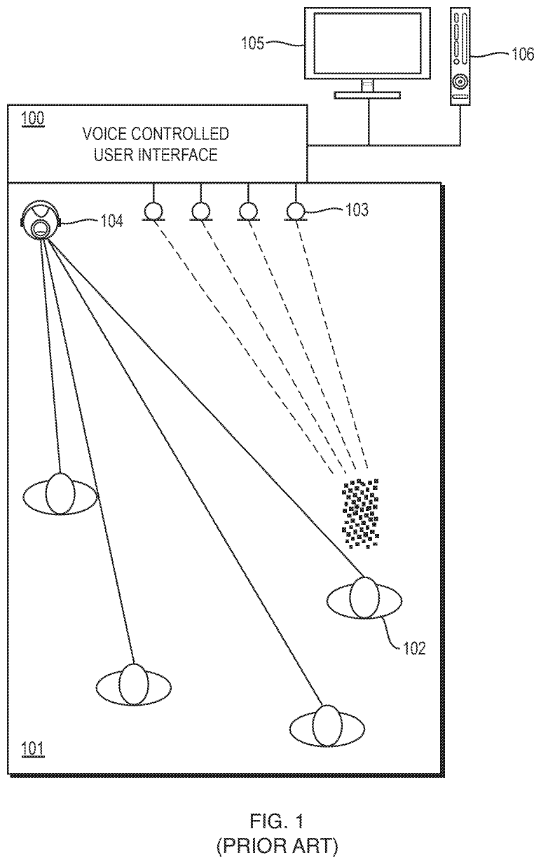

FIG. 1 illustrates an example of a prior arrangement for a voice controlled user interface 100. The figure corresponds to FIG. 1 of WO2013/137900A1 and the following description is adapted from paragraph [0019] of WO2013/137900A1. The multi-mode voice controlled user interface 100 includes at least two different operating modes. There is a broad listening mode in which the voice controlled user interface 100 broadly accepts speech inputs, e.g., via microphone array 103, without any spatial filtering from any one of multiple speakers 102 in a room 101. In broad listening mode, the voice controlled user interface 100 uses a limited broad mode recognition vocabulary that includes a selective mode activation word. When the voice controlled user interface 100 detects the activation word, it enters a selective listening mode that uses spatial filtering to limit speech inputs, e.g., from the microphone array 103, to a specific speaker 102 in the room 101 using an extended selective mode recognition vocabulary. For example, the selected specific speaker may use the voice controlled user interface 100 in the selective listening mode following a dialog process to control one or more devices such as a television 105 and/or a computer gaming console 106. The selective listening mode also may be entered based on using image processing with the spatial filtering. Once the activation word has been detected in broad listening mode, the interface may use visual image information from a camera 104 and/or a video processing engine to determine how many persons are visible and what their position is relative to the microphone array 103.

Embodiments of the invention can include an improved system that employs advanced methods, including ASR and syntactic analysis, to predict goods points in time when it acceptable (e.g., “polite”) for the system to speak. Unlike the prior approach, the improved system is listening at all times with a large vocabulary, not just selected key words, similar to a “just talk” mode.

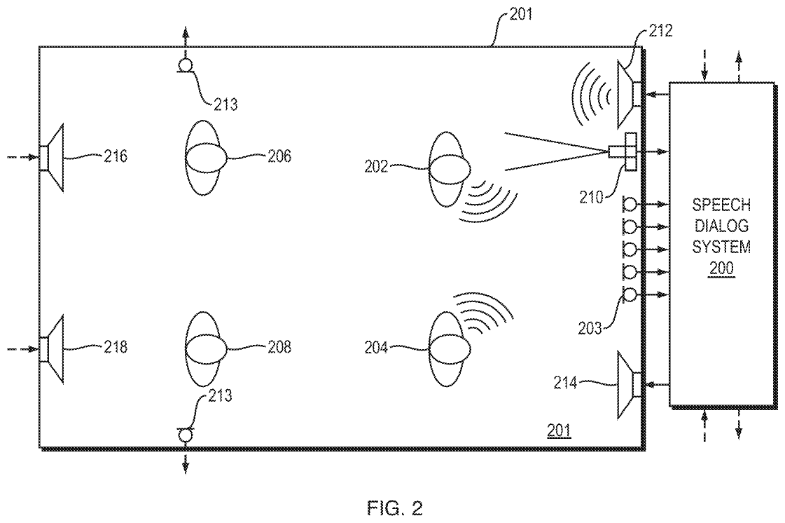

FIG. 2 illustrates a speech dialog system 200 in a vehicle, according to an example embodiment. As illustrated, there are four passengers 202, 204, 206, 208 positioned in the interior cabin 201 of the vehicle. The driver 202 and co-driver 204, positioned in the front, are depicted engaged in a conversation. Multiple microphones and loudspeakers are connected to the speech dialogue system 200. In the example shown, a microphone array 203 is positioned near the front of the cabin 201, near the driver 202 and co-driver 204. Two additional microphones 213 are position at the rear of the cabin, near the passengers 206 and 208. The loudspeakers are coupled to the dialogue system 200 to provide means to communicate with the passengers and the driver. In the arrangement illustrated in FIG. 2, there are two loudspeakers 212, 214 in the front and two loudspeakers 216, 218 in the rear. The system can make use of the microphones installed in the vehicle to recognize speech and to recognize who is speaking, e.g., whether the driver is speaking or one of the passengers. For example, the system can use beamforming with microphone array 203 to isolate voice signals coming from the driver or from one of the passengers. The system is configured to recognize, for example, that the driver is speaking to one of the passengers and the system can schedule the speech prompt accordingly. In particular, the system may not interrupt an ongoing conversation that involves the driver as the driver may not listen to the prompt from the speech dialog system, in which case the driver may miss the information being conveyed. If the speech prompt has a high degree of urgency associated with it, because it is to be delivered to the driver, for example, during navigation, the system may call attention to the prompt, for example, by announcing the prompt with a sound or a short phrase.

As illustrated in FIG. 2, a camera 210 is positioned in the interior of the vehicle facing the driver 202. The system may rely solely on available audio information but may also consider video information from the camera 210 in combination with the audio information. For example, the video camera 210 may be used to monitor the driver 202 of the vehicle and such monitoring can feed into the assessment of whether the driver is available for a speech prompt.

The dialog system 200 may use audio information from the available microphone systems in the vehicle to schedule the speech prompt. In a simple case, the microphone system includes a single microphone, which may be located near the driver 202. Speech signal enhancement typically includes applying noise reduction to the detected audio signal from the microphone. Speech can be detected based on energy in the audio signal. For example, if the total energy in a time frame is above a background noise energy, a speech is signal considered to be detected in the time frame. In a more sophisticated setting, the system my focus on the tonal part of the detected audio signal to determine whether speech is present or not. The system may also use detection of fricatives in the detected audio signal as an indication that speech is present. When multiple microphones are available, for example, two microphones in an overhead console of the vehicle, the system may employ beamforming steered towards the driver 202 or toward the passenger 204, depending on who is detected to be speaking. For example, the dialog system may have access to a signal that indicates a high value when the driver 202 is detected to be speaking and a low value when the driver is detected not to be speaking. Similarly, a speech activity signal may be available for the co-driver 204. The speech activity signal(s) can be used to detect dialog. The system can look for relative timing and other patterns among the speech activity signals of the driver and co-driver. Alternating patterns of speech activity can be indicative of dialog, and such information can be made available for further processing.

Tonal information of the detected audio signal can be used to predict when somebody who is speaking is about to stop talking. It is known from linguistics and psychology that humans use tonal and syntactic information to predict pauses in the speech of their counterpart and these methods can be modeled based on computer analysis of the tonal qualities of the speech, as further described herein. This may allow the system to predict when it is a good time to interrupt and prompt. When multiple microphones are available, such as illustrated in FIG. 2, acoustic zones may be defined and voice activity detection (VAD) information may be available for the acoustic zones. For example, in the arrangement illustrated in FIG. 2, three acoustic zones may be defined, one for each passenger in the backseats, each zone monitored by the respective microphone 213, and the third acoustic zone for the driver and passenger in the front seats, monitored by the microphone array 203.

The camera 210 can be used to measure cognitive load based on observation of the driver 202. For example, the camera 210 can provide a video signal, which can be used to observe the driver 202 as the driver is operating the vehicle. In addition, other modalities of monitoring the driver may be available in the vehicle or may become available, such as heart rate monitoring or other physiological monitoring. For example, a wearable device on the driver, such as a smartwatch or fitness tracker, can provide such monitoring information. The information may be available to the dialog system through wireless connectivity, e.g., Bluetooth® technology, of the wearable device. The speech dialog system may consider a measure of cognitive load of the driver 202 in making a determination when to prompt and how to present information relevant to the driver when prompting.

With access to multiple microphones and speech signal enhancement (SSE), the system can determine if passengers 206, 208 are talking in the back seat as opposed to the driver 202 being in a conversation with the co-driver 204 or another passenger. If only passengers in the back seat are talking, the system may not want to wait to prompt the driver with important information. The SEE technology may also provide scene information of who is currently speaking based on voice biometrics and/or other available information. If the information indicates that the driver 202 is engaged in a conversation, the system may first call attention before delivering a prompt, to increase the likelihood that the prompt will not interrupt the ongoing conversation, that the driver will pay attention to the information being delivered, or both. The system may trade off (or weigh) perceived rudeness of the interruption against urgency of the information to be presented to the user. If the system cannot determine a good point in the conversation at the current time to present information, the system may choose to wait until a later time. However, if faced with a prompt having a high measure of urgency or if the urgency of a prompt increases to a certain threshold, the system may decide to interrupt the conversation, at the risk of being perceived as rude.

An advantage of a speech dialog system according to an embodiment of the present invention is that the system waits until there appears a reasonable gap in the detected conversation between users. The system trades off urgency versus politeness in order to determine when to prompt and how to prompt. If it is possible to wait a moment, the prompt can be put in a queue until it is possible to prompt without interrupting any user. If it cannot be avoided to interrupt an ongoing conversation the system can choose a polite way to first make the user aware of an important message to be prompted.

Speech Signal Enhancement (SSE) is typically applied as preprocessing for speech dialog systems. A prominent application of SSE is being the automotive use case. An integral part of SSE is the detection of speech activity. This is true for both single- as well as multi-microphone systems. For multi-microphone SSE, it is possible to detect which passenger is currently speaking. This also allows for the detection of a conversation, e.g., between the driver and co-driver, or between the driver and another passenger. An SSE module may provide information about speech activity to a dialog manager so that the prompting behavior of the dialog-system can be controlled accordingly. The dialog manager may consider the information about an ongoing dialog among the passengers in order to display a prompt only when none of the passengers are talking (by looking for gaps in the conversation, or predicting such gaps based on tonal and/or syntactic information). The prompts may be queued and scheduled according to their urgency, and, in particular, so as to not interrupt any detected speech in the vehicle. In case speech is detected and an urgent prompt is scheduled, the system may, for instance, ask for attention before prompting the scheduled message.

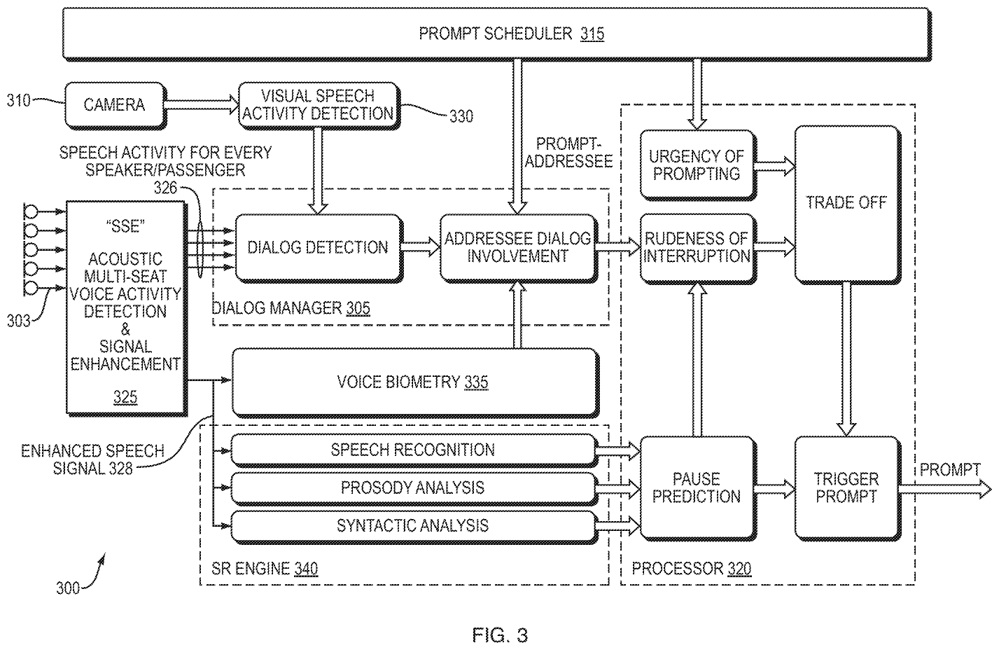

FIG. 3 is a block diagram of a system and associated method for scheduling a speech prompt, according to an example embodiment. A speech dialog system 300 for intelligently scheduling a speech prompt includes a dialog manager 305, a prompt scheduler 315 that is configured to schedule a speech prompt, and a processor 320 that is in communication with the dialog manager 305 and scheduler 315. The dialog manager 305 is configured to monitor an acoustic environment, e.g., a room, a cabin of car, etc., to detect an intended addressee's availability for a speech prompt. The speech prompt has a measure of urgency corresponding with the speech prompt. Both the speech prompt and the measure of urgency may be provided by the prompt scheduler 315.

As illustrated in FIG. 3, the system further includes a microphone system 303, which can include a microphone array as shown, a single microphone, or combinations thereof. The microphone system 303 is configured to detect an acoustic signal associated with the acoustic environment. The microphone system 303 provides the detected acoustic signal to a speech processor 325, which is in communication with the dialog manager 305. The speech processor 325 applies speech signal enhancement (SSE) to the detected acoustic signal to produce an enhanced detected acoustic signal. The speech processor 325 is configured to generate one or more outputs as a function of the enhanced detected acoustic signal. In the example shown, a speech activity signal 326 and an enhanced speech signal 328 are generated. The speech activity signal 326 can include multiple speech activity signals, one for each speaker. The dialog manager 305 detects dialog from the speech activity signal 326. A camera 310 is provided to capture a video signal associated with the acoustic environment. A video processor 330 is in communication with the camera 310 and the dialog manager 305. The video processor 330 receives the video signal and applies visual speech activity detection to the video signal to generate a visual speech activity signal. The dialog manager 305 receives the visual speech activity signal and can use it for dialog detection, in addition to using the speech activity signal 326.

As shown in FIG. 3, the system 300 can further include a voice analyzer 335 in communication with the speech processor 325 and the dialog manager 305. The voice analyzer 335 can apply voice biometry analysis to the enhanced speech signal 328 using, for example, known techniques. Based on the voice biometry analysis, the system can detect involvement of the intended addressee in the dialog. The system can further include a speech recognition (SR) engine 340 in communication with the speech processor 325 and the processor 320. The SR engine 340 is configured to process the enhanced speech signal 328 received from the speech processor 325. The SR engine 340 can apply any combination of automatic speech recognition, prosody analysis, and syntactic analysis to the enhanced speech signal to generate one or more speech analysis results. Prosody analysis can include analysis of various auditory measures, but may also include analysis of acoustic measures. Examples of auditory variables include pitch of the voice (varying between low and high), length of sounds (varying between short and long) loudness, or prominence (varying between soft and loud), and timbre (quality of sound). Examples of acoustic measures include fundamental frequency (measured in hertz), duration (measured in time units such as milliseconds or seconds), intensity, or sound pressure level (measured in decibels), spectral characteristics (distribution of energy at different parts of the audible frequency range). The processor 320 is configured to apply pause prediction to the enhanced speech signal based on one or more speech analysis results.

In general, the processor 320 is configured to predict a time that is convenient to present the speech prompt to the intended addressee based on the intended addressee's availability, and cause the scheduler 315 to schedule the speech prompt based on the predicted time and a measure of urgency. The processor 320 can be configured to predict the time that is convenient to present the speech prompt by estimating rudeness of interruption based on the pause prediction and dialog detection to generate a measure of rudeness. The processor 320 can schedule or cause the scheduler 315 to schedule the speech prompt by trading off the measure of urgency and the measure of rudeness. As further described herein, the measure of rudeness can be estimated using a cost function that includes cost for presence of an utterance, cost for presence of a conversation, and cost for involvement of the intended addressee in the conversation. Scheduling the speech prompt can include trading off the measure of urgency and the measure of rudeness. The trading off can include computing an urgency-rudeness ratio as the ratio of the measure of urgency, e.g., U(k), and the measure of rudeness, e.g., R(k). The prompt can be scheduled based on a comparison of the urgency-rudeness ratio to a threshold T.

The arrangement of system illustrated in FIG. 3 is shown for one intended “prompt-addressee.” In some embodiments, there can be as many of such arrangements as there are possible prompt-addressees. In this context, it should be noted that SSE can separate the voices of multiple speakers as described in the context of FIG. 1 and further described in WO2013/137900A1. The ability of SSE to separate voices of multiple speakers relates to the embodiments of the present invention because this feature can be used to restrict the dialog to the desired speaker (e.g., the intended addressee) making sure that others cannot talk to the dialog system.

A camera or computer vision (CV) software can be used to determine if someone is speaking or not, also to detect if someone may be too distracted to listen.

Instead of just using SSE or voice activity detection (VAD) to find “speaking pauses,” the system can also employ automatic speech recognition (ASR) and natural language understanding (NLU) on what is spoken, parse what is spoken and predict good points in time when it is socially acceptable to interrupt. This can be based on the Transition Relevance Place (TRP) theory. Previously, TRP theory has been used for the reverse case, i.e., predicting when it is likely that users interrupt the system, as described in U.S. Pat. No. 9,026,443, which is incorporated herein by reference. For example, it is generally considered to be more acceptable to interrupt at the end of syntactic phrases or sentences than in the middle of such units. As described in U.S. Pat. No. 9,026,443, when a human listener wants to interrupt a human speaker in a person-to-person interaction, the listener tends to choose specific contextual locations in the speaker's speech to attempt to interrupt. People are skilled at predicting these Transition Relevance Places (TRPs). Cues that are used to predict such TRPs include syntax, pragmatics (utterance completeness), pauses and intonation patterns. Human listeners tend to use these TRPs to try to acceptably take over the next speaking turn, to avoid being seen as exhibiting “rude” behavior.

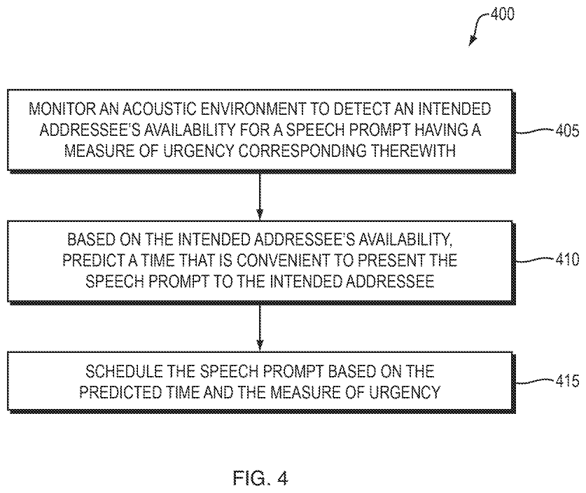

FIG. 4 is a flow chart illustrating a method 400 for intelligently scheduling a speech prompt, according to an example embodiment. In scheduling a speech prompt to be presented to an intended addressee, e.g. a driver of a car, the above apparatus and system, or other apparatus and systems, can employ the following example method 400, which includes monitoring 405 an acoustic environment to detect an intended addressee's availability for a speech prompt, where the speech prompt has a measure of urgency corresponding therewith. Monitoring the acoustic environment can include detecting an acoustic signal associated with the acoustic environment to produce a detected acoustic signal, applying speech signal enhancement to the detected acoustic signal to produce an enhanced detected acoustic signal, and generating an enhanced speech signal and a speech activity signal as a function of the enhanced detected acoustic signal.

Based on the intended addressee's availability, a time is predicted 410 that is convenient to present the speech prompt to the intended addressee and the speech prompt is scheduled 415 based on the predicted time and the measure of urgency.

Example: Spatial Voice Activity Based Dialog Detection

It is assumed that SSE provides voice activity information for at least two speakers. The speakers are distinguished spatially (driver and passenger seat for instance). The voice activity information is furthermore available on a frame basis (e.g., every 10 ms). In a first step the frame-based speech activity information can be processed to remove short pauses and hence to provide coarse information about the presence of an utterance per speaker. Secondly, the “utterance present information” of all speakers is considered jointly in their temporal sequence. A dialog among two speakers can be detected based on the “utterance transition from one speaker to another within a predefined amount of time.” For example, an utterance from speaker 1 is followed by an utterance of speaker 2, whereas the gap between both is no longer than 3 seconds, for instance. This also includes simultaneous utterances of the two speakers. A transition back to speaker 1 is of course an indication that this dialog continuous. Utterance transition may also take place among several speakers, which may be used to monitor how many speakers are involved in the dialog. In particular, the information is available on who is involved in the conversation. Generally speaking, conversations can be detected based on tracking the temporal sequence of utterance transitions.

Example: Measuring Rudeness of Interruption

To quantify how ‘rude’ it would be to interrupt speech as part of a conversation, or even without a detected conversation, a cost function can be used. This cost function can include:
a) A cost α_{P} for the general presence of an utterance, say P(k)∈[0 1]. This would be zero only if no utterance is present. Here, k denotes the time frame.
b) A cost αfor the presence of a conversation C(k)∈[0 1].
c) A cost α_{I} for the involvement of the prompt-addressee (speaker with index n) in the conversation Iₙ(k)∈[0 1].

A possible metric to combine these factors is:

$${R}_{n} ( k ) = {α}_{I} \cdot MAX \{ {I}_{n} ( k ) , {α}_{{I}_{M I N}} \} * \frac{( {α}_{P} \cdot P ( k ) + {α}_{C} \cdot C ( k ) )}{{α}_{P} + {α}_{C}}$$

The resulting value would also lie in the same interval [0 1] as all individual contributions. Values close to 1 indicate a high level of rudeness. The involvement of the prompt-addressee is “floored” to a minimum value α_{I}_{_{MIN}} in order to account for the rudeness of interrupting an ongoing conversation to which the prompt-addressee has not yet contributed actively but may be listening to.

Example: Trading Off Rudeness vs Urgency

Given that the urgency Uₙ(k) of each scheduled prompt is available in the system, it can be traded-off against the Rudeness Rₙ(k). Note that Uₙ(k) is also speaker dependent. The urgency is also scaled between zero and 1 to allow for a meaningful comparison with rudeness. The decision to display a prompt can be made based on requiring the Urgency-Rudeness Ratio to exceed some chosen threshold:

$$\frac{U ( k )}{R ( k )} > T$$

The threshold T can be used to adjust the “politeness” of the system. It may furthermore be considered to trigger a prompt only if the Urgency-Rudeness Ratio has exceeded the threshold for some time in order to achieve robustness.

It should be understood that the example embodiments described above may be implemented in many different ways. In some instances, the various methods and machines described herein may each be implemented by a physical, virtual or hybrid general purpose or application specific computer having a central processor, memory, disk or other mass storage, communication interface(s), input/output (I/O) device(s), and other peripherals. The general purpose or application specific computer is transformed into the machines that execute the methods described above, for example, by loading software instructions into a data processor, and then causing execution of the instructions to carry out the functions described, herein.

As is known in the art, such a computer may contain a system bus, where a bus is a set of hardware lines used for data transfer among the components of a computer or processing system. The bus or busses are essentially shared conduit(s) that connect different elements of the computer system, e.g., processor, disk storage, memory, input/output ports, network ports, etc. that enables the transfer of information between the elements. One or more central processor units are attached to the system bus and provide for the execution of computer instructions. Also attached to the system bus are typically I/O device interfaces for connecting various input and output devices, e.g., keyboard, mouse, displays, printers, speakers, etc., to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

In certain embodiments, the procedures, devices, and processes described herein constitute a computer program product, including a computer readable medium, e.g., a removable storage medium such as one or more DVD-ROM's, CD-ROM's, diskettes, tapes, etc., that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transitory machine-readable medium, which may be read and executed by one or more processors. A non-transient machine-readable medium may include any mechanism for storing or transmitting information in a form readable by a machine, e.g., a computing device. For example, a non-transient machine-readable medium may include read only memory (ROM); random access memory (RAM); magnetic disk storage media; optical storage media; flash memory devices; and others.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It also should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method for intelligently scheduling a speech prompt in a speech dialog system, the method comprising:
monitoring an acoustic environment to detect an intended addressee's availability for a speech prompt having a measure of urgency corresponding therewith;
based on the intended addressee's availability, predicting a time that is convenient to present the speech prompt to the intended addressee; and
scheduling the speech prompt based on the predicted time and the measure of urgency.

2. The method of claim 1, wherein monitoring the acoustic environment includes detecting an acoustic signal associated with the acoustic environment to produce a detected acoustic signal, applying speech signal enhancement to the detected acoustic signal to produce an enhanced detected acoustic signal, and generating an enhanced speech signal and a speech activity signal as a function of the enhanced detected acoustic signal.

3. The method of claim 2, further comprising detecting dialog from the speech activity signal.

4. The method of claim 3, further comprising capturing a video signal associated with the acoustic environment and applying visual speech activity detection to the video signal to generate a visual speech activity signal, wherein the dialog is detected from the speech activity signal and the visual speech activity signal.

5. The method of claim 3, further comprising applying voice biometry analysis to the enhanced speech signal to detect involvement of the intended addressee in the dialog.

6. The method of claim 3, further comprising:
applying one or more of automatic speech recognition, prosody analysis, and syntactic analysis to the enhanced speech signal to generate one or more speech analysis results; and
applying pause prediction to the enhanced speech signal based on the one or more speech analysis results.

7. The method of claim 6, wherein predicting the time that is convenient to present the speech prompt includes estimating rudeness of interruption based on the pause prediction and dialog detection to generate a measure of rudeness.

8. The method of claim 7, wherein the measure of rudeness is estimated using a cost function that includes cost for presence of an utterance, cost for presence of a conversation, and cost for involvement of the intended addressee in the conversation.

9. The method of claim 8, wherein scheduling the speech prompt includes trading off the measure of urgency and the measure of rudeness.

10. The method of claim 9, wherein the trading off includes computing an urgency-rudeness ratio as the ratio of the measure of urgency and the measure of rudeness, and wherein the prompt is scheduled based on a comparison of the urgency-rudeness ratio to a threshold.

11. A speech dialog system for intelligently scheduling a speech prompt, the system comprising:
a dialog manager configured to monitor an acoustic environment to detect an intended addressee's availability for a speech prompt having a measure of urgency corresponding therewith;
a scheduler configured to schedule the speech prompt; and
a processor in communication with the dialog manager and scheduler, and configured to (i) predict a time that is convenient to present the speech prompt to the intended addressee based on the intended addressee's availability, and (ii) cause the scheduler to schedule the speech prompt based on the predicted time and the measure of urgency.

12. The system of claim 11, further comprising:
a microphone system configured to detect an acoustic signal associated with the acoustic environment to produce a detected acoustic signal; and
a speech processor in communication with the dialog manager and configured to apply speech signal enhancement to the detected acoustic signal to produce an enhanced detected acoustic signal, the speech processor configured to generate an enhanced speech signal and a speech activity signal as a function of the enhanced detected acoustic signal.

13. The system of claim 12, wherein the dialog manager is configured to detect dialog from the speech activity signal.

14. The system of claim 13, further comprising:
a camera configured to capture a video signal associated with the acoustic environment; and
a video processor in communication with the dialog manager and configured to apply visual speech activity detection to the video signal to generate a visual speech activity signal, wherein the dialog manager is configured to detect the dialog from the speech activity signal and the visual speech activity signal.

15. The system of claim 13, further comprising a voice analyzer in communication with the dialog manager and configured to apply voice biometry analysis to the enhanced speech signal to detect involvement of the intended addressee in the dialog.

16. The system of claim 13, further comprising a speech recognition engine in communication with the processor and configured to apply one or more of automatic speech recognition, prosody analysis, and syntactic analysis to the enhanced speech signal to generate one or more speech analysis results, wherein the processor is further configured to apply pause prediction to the enhanced speech signal based on the one or more speech analysis results.

17. The system of claim 16, wherein the processor is configured to predict the time that is convenient to present the speech prompt by estimating rudeness of interruption based on the pause prediction and dialog detection to generate a measure of rudeness.

18. The system of claim 17, wherein the processor is configured to cause the scheduler to schedule the speech prompt by trading off the measure of urgency and the measure of rudeness.

19. A non-transitory computer-readable medium including computer code instructions stored thereon for intelligently scheduling a speech prompt in a speech dialog system, the computer code instructions, when executed by a processor, cause the system to perform at least the following:
monitor an acoustic environment to detect an intended addressee's availability for a speech prompt having a measure of urgency corresponding therewith;
based on the intended addressee's availability, predict a time that is convenient to present the speech prompt to the intended addressee; and
schedule the speech prompt based on the predicted time and the measure of urgency.
